(19) United States
(12) Patent Application Publication
(10) Pub. No.: US 2011/0115992 A1
(43) Pub. Date: May 19, 2011

(54) PROJECTION DISPLAY APPARATUS

(75) Inventors: Makoto MAEDA, Osaka-City (JP); Ken MASHITANI, Osaka (JP)

(73) Assignee: SANYO ELECTRIC CO., LTD., Moriguchi City (JP)

(21) Appl. No.: 12/972,049

(22) Filed: Dec. 17, 2010

Related U.S. Application Data
(63) Continuation-in-part of application No. PCT/JP2009/061051, filed on Jun. 17, 2009.

(30) Foreign Application Priority Data
Jun. 17, 2008 (JP) 2008-158133

(51) Int. Cl. G02F 1/1335; G03B 21/16

(52) U.S. Cl. 349/5; 353/52

(57) ABSTRACT

Projection display apparatus 100 is equipped with a cooling device 300, which comprises an air passage as the passage of the air and a heat absorber that cools off the air flows in the air passage, and a light source controller 220, which controls the amount of light irradiated on the optical elements (liquid crystal panel 50 and the like). The optical elements are provided in the air passage. When the heat absorber receives an operation termination instruction to terminate the operation of the apparatus itself, it will end the cooling of the air flowing in the air passage. the light source keeps emitting the light, even in a case of receiving the operation termination instruction.

### CROSS REFERENCE TO RELATED APPLICATIONS

This is a continuation-in-part Application of PCT International Application No. PCT/JP2009/061051 (filed Jun. 17, 2009), which in turn based upon and claims the benefit of priority from Japanese Patent Application No. 2008-158133, filed on Jun. 17, 2008; the entire contents of which are incorporated herein by reference.

### TECHNICAL FIELD

The present invention relates to a projection display apparatus including a light source, an optical element irradiated with light emitted from the light source, and a projection optics which projects light emitted from the optical element.

### BACKGROUND ART

A projection display apparatus is heretofore known which includes: a light source; an optical element configured to modulate light emitted from the light source; and a projection optics configured to project the light emitted from the optical element. Examples of the optical element include a transmissive liquid crystal panel, a reflective liquid crystal panel, and a DMD (Digital Micromirror Device).

In the projection display apparatus described above, the optical element is irradiated with the light emitted from the light source. In other words, the optical element is heated by the light emitted from the light source.

Thus, the projection display apparatus generally includes a cooling device configured to cool a cooling target such as the optical element. The cooling target such as the optical element is provided on the optical path of the light emitted from the light source. For this reason, it is preferable to use an air-cooled cooling device as the cooling device so that the cooling device may not interfere with the light emitted from the light source. It should be noted that it is not preferable to use a liquid-cooled cooling device and the like.

For example, the air-cooled cooling device includes a cooler configured to cool the air flowing through an air duct (air passage). A Peltier device is used as the cooler, for example. The optical element is provided in the air passage. The optical element is cooled by the air (cool air) flowing through the air passage (JP-A 2005-121250, for example).

Meanwhile, when the projection display apparatus is powered off, the driving of the cooler terminates the cooling of the air flowing through the air passage at the same timing as the driving of the light source terminates the light emission, in general.

In this respect, once the light source terminates the light emission, the optical element is no longer irradiated with the light from the light source, and thus finishes being heated by the light emitted from the light source 10. In the meantime, the time for the temperature of the air flowing in the air passage to return to an ordinary temperature (e.g., room temperature) is longer than the time required until the heating of the optical element is terminated in response to the termination of the light emission from the light source.

In other words, a period of time occurs during which the temperature of the air flowing in the air passage (hereinafter, the temperature of the cool air) is lower than the temperature of the outside air. Hence, after the heating of the optical element ends, a cooling wind having a cooling performance closer to that exerted in the cooling of the optical element is introduced toward the optical element. Along with this, the temperature of the cool air rapidly lowers the element temperature of the optical element, and the element temperature falls below the dew-point temperature, which may possibly induce the formation of dew in the optical element.

In this respect, although the air passage is preferably kept substantially hermetically sealed, some of the outside air may enter the air passage. For this reason, if the element temperature falls below the dew-point temperature, dew may be formed in the optical element due to the outside air which have entered the air passage and comes into contact with the optical element. Incidentally, if the element temperature falls below 0 degree, frost may possibly be formed in the optical element.

### SUMMARY OF INVENTION

A projection display apparatus (projection display apparatus 100) of a first aspect includes a light source (light source 10), an optical element (liquid crystal panel 50, compensation plate 51, incident-side polarizing plate 52, incident-side pre-polarizing plate 53, output-side pre-polarizing plate 54, and output-side polarizing plate 55) irradiated with light emitted from the light source, and a projection optics (projection lens unit 160) which projects light emitted from the optical element. The projection display apparatus includes: a cooling device (cooling device 320) including an air passage (air passage 310) being a passage of an air, and a cooler (heat absorber 320) which cools the air flowing through the air passage. The optical element is provided in the air passage. The cooler terminates the cooling of the air flowing through the air passage upon receipt of an operation termination instruction to terminate an operation of the projection display apparatus. The light source keeps emitting the light even in a case of receiving the operation termination instruction.

In the first aspect, the projection display apparatus further includes an optical element controller (image controller 240) which controls the optical element. The optical element includes a liquid crystal panel, an incident-side polarizing plate (incident-side polarizing plate 52) provided at a light-incident-surface side of the liquid crystal panel, and an output-side polarizing plate (output-side polarizing plate 54) provided at a light-outgoing-surface side of the liquid crystal panel. Upon receipt of the operation termination instruction, the optical element controller controls the liquid crystal panel so that the light emitted from the light source is shielded by the output-side polarizing plate.

incident-side polarizing plate 52

In the first aspect, the projection display apparatus further includes: an optical element controller which controls the optical element; and a light-shielding shutter (light-shielding shutter 80) provided at a light-outgoing side of the optical element. The optical element includes a liquid crystal panel, an incident-side polarizing plate provided at alight-incident-surface side of the liquid crystal panel, and an output-side polarizing plate provided at a light-outgoing-surface side of the liquid crystal panel. Upon receipt of the operation termination instruction, the optical element controller controls the liquid crystal panel so that the light emitted from the light source is transmitted through the output-side polarizing plate. Upon receipt of the operation termination instruction, the light-shielding shutter shields the light emitted from the optical element.

In the first aspect, the light-shielding shutter is provided in the air passage.

In the first aspect, the projection display apparatus, further includes a light-amount controller (light-source controller 220) which controls a light amount of light to be irradiated on the optical element. The light amount of light to be irradiated on the optical element is set at a predetermined light amount in a normal operation state. Upon receipt of the operation termination instruction, the light-amount controller performs control such that light having a smaller light amount than the predetermined light amount is irradiated on the optical element.

In the first aspect, the light source include a plurality of light sources. Upon receipt of the operation termination instruction, the light-amount controller performs control such that only light emitted from some of the plurality of light sources is irradiated on the optical element.

In the first aspect, the cooling device includes a circulator (circulating fan 370) which circulates the air in the air passage. The circulator circulates the air in the air passage even in the case of receiving the operation termination instruction.

In the first aspect, the light-amount controller controls the light amount of light to be irradiated on the optical element by controlling power supplied to the light source.

In the first aspect, the light-amount controller performs control such that the light having a smaller light amount than the predetermined light amount is irradiated on the optical element until a predetermined length of time passes after the receipt of the operation termination instruction.

In the first aspect, the cooling device includes a temperature sensor (temperature sensor 381) which detects a temperature in the air passage. The light-amount controller performs control such that the light having a smaller light amount than the predetermined light amount is irradiated on the optical element until the temperature detected by the temperature sensor increases to a predetermined temperature after the receipt of the operation termination instruction.

In the first aspect, the cooling device includes a temperature sensor (temperature sensor 382) which detects a temperature of the cooler. The light-amount controller performs control such that the light having a smaller light amount than the predetermined light amount is irradiated on the optical element until the temperature detected by the temperature sensor increases to a predetermined temperature after the receipt of the operation termination instruction.

In the first aspect, the projection display apparatus further includes a light-amount iris unit (light-amount iris unit 70) provided between the light source and the optical element and formed of a light-shielding member. The light-amount controller controls the light amount of light to be irradiated on the optical element by controlling the light-amount iris unit.

### BRIEF DESCRIPTION OF DRAWINGS

FIG. 1 is a diagram showing a projection display apparatus 100 according to a first embodiment.

FIG. 2 is a diagram showing a cooling device 300 according to the first embodiment.

FIG. 3 is a diagram for explaining a refrigerant according to the first embodiment.

FIG. 4 is a block diagram showing a control unit 200 according to the first embodiment.

FIG. 5 is a diagram for explaining the start of the cooling of optical elements according to the first embodiment.

FIG. 6 is a diagram for explaining the termination of the cooling of the optical elements according to the first embodiment.

FIG. 7 is a diagram showing a projection display apparatus 100 according to a second embodiment.

FIG. 8 is a block diagram showing a control unit 200 according to the second embodiment.

FIG. 9 is a diagram showing a projection display apparatus 100 according to a third embodiment.

FIG. 10 is a conceptual diagram showing the arrangement of light sources 10 according to the third embodiment.

FIG. 11 is a conceptual diagram showing the arrangement of light sources 10 according to a modification of the third embodiment.

FIG. 12 is a diagram showing a projection display apparatus 100 according to a fourth embodiment.

FIG. 13 is an enlarged diagram showing a cross dichroic prism 60 and its vicinity according to a fifth embodiment.

FIG. 14 is a block diagram showing a control unit 200 according to a fifth embodiment.

FIG. 15 is a diagram showing a projection display apparatus 100 according to a sixth embodiment.

FIG. 16 is a diagram showing a projection display apparatus 100 according to a seventh embodiment.

### MODES FOR CARRYING OUT THE INVENTION

In the following, projection display apparatuses according to the embodiments of the present invention are described with reference to the drawings. Note that, in the following description of the drawings, same or similar reference signs denote same or similar elements and portions.

In addition, it should be noted that the drawings are schematic and ratios of dimensions and the like are different from actual ones. Therefore, specific dimensions and the like should be determined in consideration of the following description. Moreover, the drawings also include portions having different dimensional relationships and ratios from each other.

### First Embodiment

### Configuration of Projection Display Apparatus

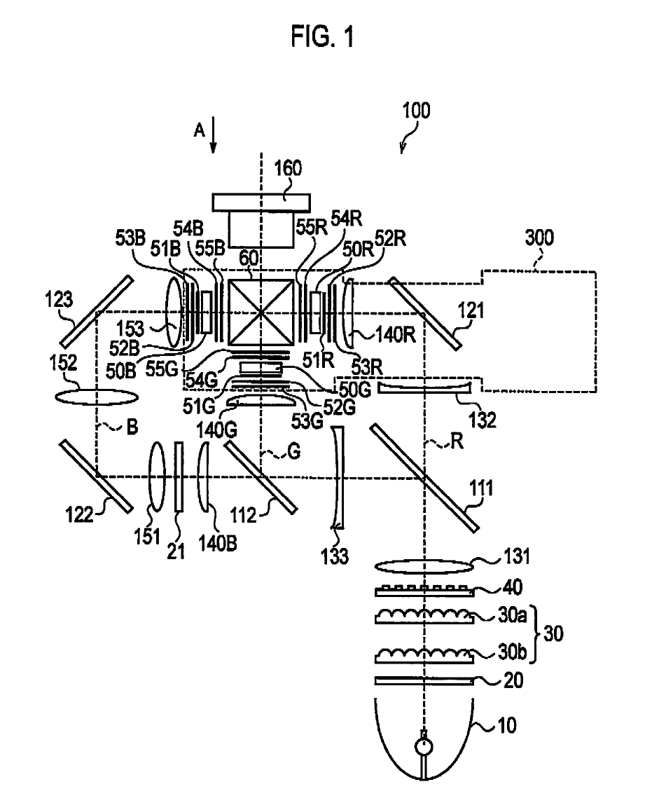

Hereinbelow, the configuration of a projection display apparatus according to a first embodiment is described with reference to the drawings. FIG. 1 is a diagram showing a projection display apparatus 100 according to the first embodiment.

As shown in FIG. 1, the projection display apparatus 100 includes a light source 10, a UV/IR cut filter 20, a fly-eye lens unit 30, a PBS array 40, multiple liquid crystal panels 50 (a liquid crystal panel 50R, a liquid crystal panel 50G, and a liquid crystal panel 50B), and a cross dichroic prism 60.

Examples of the light source 10 include a UHP lamp configured to emit white light. Light emitted by the light source 10 includes red component light, green component light, and blue component light.

The UV/IR cut filter 20 transmits visible light components (red component light, green component light, and blue component light). On the other hand, the UV/IR cut filter 20 shields invisible light components (such as an infrared component and an ultraviolet component).

The fly-eye lens unit 30 equalizes the light emitted from the light source 10. Specifically, the fly-eye lens unit 30 includes a fly-eye lens 30a and a fly-eye lens 30b.

The fly-eye lens 30a and the fly-eye lens 30b are each formed of multiple microlenses. Each of the microlenses condense the light emitted from the light source 10 so that the light emitted from the light source 10 may be irradiated on the entire surface of each liquid crystal panel 50.

The PBS array 40 aligns the polarization state of the light emitted from the fly-eye lens unit 30. For example, the PBS array 40 aligns the light emitted from the fly-eye lens unit 30 to P-polarization.

The liquid crystal panel 50R modulates the red component light by rotating the polarization direction of the red component light. A compensation plate 51R configured to improve a contrast ratio and transmittance is provided at the light-incident-surface side of the liquid crystal panel 50R.

An incident-side polarizing plate 52R is provided at the light-incident-surface side of the compensation plate 51R. The incident-side polarizing plate 52R is configured to transmit light having one polarization direction (for example, P-polarization), and to shield light having any other polarization direction (for example, S-polarization). An incident-side pre-polarizing plate 53R is provided at the light-incident-surface side of the incident-side polarizing plate 52R. The incident-side pre-polarizing plate 53R is configured to absorb light whose irradiation on the incident-side polarizing plate 52R is undesirable, to thus prevent the irradiation of the light on the incident-side polarizing plate 52R, and to thereby improve reliability, lifetime, and contrast.

Meanwhile, an output-side pre-polarizing plate 54R is provided at the light-outgoing-surface side of the liquid crystal panel 50R. The output-side pre-polarizing plate 54R is configured to absorb light whose irradiation on an output-side polarizing plate 55R described later is undesirable, to thus prevent the irradiation of the light on the output-side polarizing plate 55R, and to thereby improve reliability, lifetime, and contrast. The output-side polarizing plate 55R is provided at the light-outgoing-surface side of the output-side pre-polarizing plate 54R. The output-side polarizing plate 55R is configured to shield light having one polarization direction (for example, P-polarization), and to transmit light having any other polarization direction (for example, S-polarization).

Similarly, the liquid crystal panel 50G modulates the green component light by rotating the polarization direction of the green component light. A compensation plate 51G, an incident-side polarizing plate 52G, and an incident-side pre-polarizing plate 53G are provided at the light-incident-surface side of the liquid crystal panel 50G. Meanwhile, an output-side pre-polarizing plate 54G and an output-side polarizing plate 55G are provided at the light-output-surface side of the liquid crystal panel 50G.

Similarly, the liquid crystal panel 50B modulates the blue component light by rotating the polarization direction of the blue component light. A compensation plate 51B, an incident-side polarizing plate 52B, and an incident-side pre-polarizing plate 53B are provided at the light-incident-surface side of the liquid crystal panel 50B. Meanwhile, an output-side pre-polarizing plate 54B and an output-side polarizing plate 55B are provided at the light-output-surface side of the liquid crystal plate 50B.

The cross dichroic prism 60 combines the light beams emitted from the liquid crystal panels 50R, 50G, and 50B. Then, the cross dichroic prism 60 causes the combined light to go out toward a projection lens unit 160.

The projection display apparatus 100 further includes a mirror group (a dichroic mirror 111, a dichroic mirror 112, reflection mirrors 121 to 123) and a lens group (condenser lenses 131 to 133, a condenser lens 140R, a condenser lens 140G, a condenser lens 140B, and relay lenses 151 to 153).

The dichroic mirror 111 transmits the red component light of the light emitted from the PBS array 40. The dichroic mirror 111 reflects the green component light and the blue component light of the light emitted from the PBS array 40.

The dichroic mirror 112 transmits the blue component light out of the light reflected by the dichroic mirror 111. The dichroic mirror 112 reflects the green component light out the light reflected by the dichroic mirror 111.

The reflection mirror 121 reflects the red component light to guide the red component light toward the liquid crystal panel 50R. The reflection mirrors 122 and 123 reflect the blue component light to guide the blue component light toward the liquid crystal panel 50B.

The condenser lens 131 is a lens configured to condense the white light emitted from the light source 10. The condenser lens 132 is configured to condense the red component light transmitted through the dichroic mirror 111. The condenser lens 133 is configured to condense the green component light and the blue component light reflected by the dichroic mirror 111.

The condenser lens 140R makes the red component light into substantially parallel light so that the red component light can be irradiated on the liquid crystal panel 50R. The condenser lens 140G makes the green component light into substantially parallel light so that the green component light can be irradiated on the liquid crystal panel 50G. The condenser lens 140B makes the blue component light into substantially parallel light so that the blue component light can be irradiated on the liquid crystal panel 50B. A UV cut filter configured to shield an ultraviolet component is provided at the light-outgoing-surface side of the condenser lens.

The relay lenses 151 to 153 form an approximate image of the blue component light on the liquid crystal panel 50B while suppressing expansion of the blue component light.

The projection display apparatus 100 further includes the projection lens unit 160. The projection lens unit 160 projects the combined light (image light) emitted from the cross dichroic prism 60 on the screen or the like.

In this respect, the projection display apparatus 100 includes a cooling device 300 configured to cool optical elements included in the projection display apparatus 100. The cooling device 300 cools the optical elements such as the liquid crystal panels 50, the compensation plates 51, the incident-side polarizing plates 52, the incident-side pre-polarizing plates 53, the output-side pre-polarizing plates 54, and the output-side polarizing plates 55.

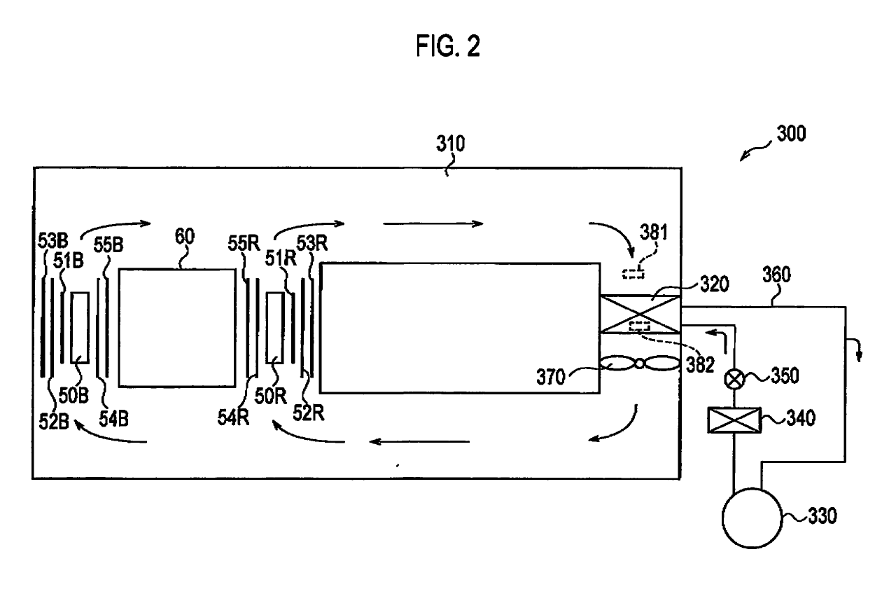

Specifically, the cooling device 300 includes an air passage which is a passage of the air. The cooling device 300 circulates the air in the air passage. In other words, the cooling device 300 cools the air flowing in the air passage. The cooling device 300 will be described later in detail (see FIG. 2).

### (Configuration of Cooling Device)

Hereinbelow, the configuration of the cooling device according to the first embodiment is described with reference to the drawings. FIG. 2 is a diagram showing the cooling device 300 according to the first embodiment. Here, FIG. 2 is a diagram of the projection display apparatus 100 seen in the A direction shown in FIG. 1.

As shown in FIG. 2, the cooling device 300 includes an air passage 310, a heat absorber 320, a compressor 330, a radiator 340, a decompressor 350, a refrigerant passage 360, and a circulating fan 370. Note that the air passage 310 is made of a heat-insulating material, and is kept substantially hermetically sealed.

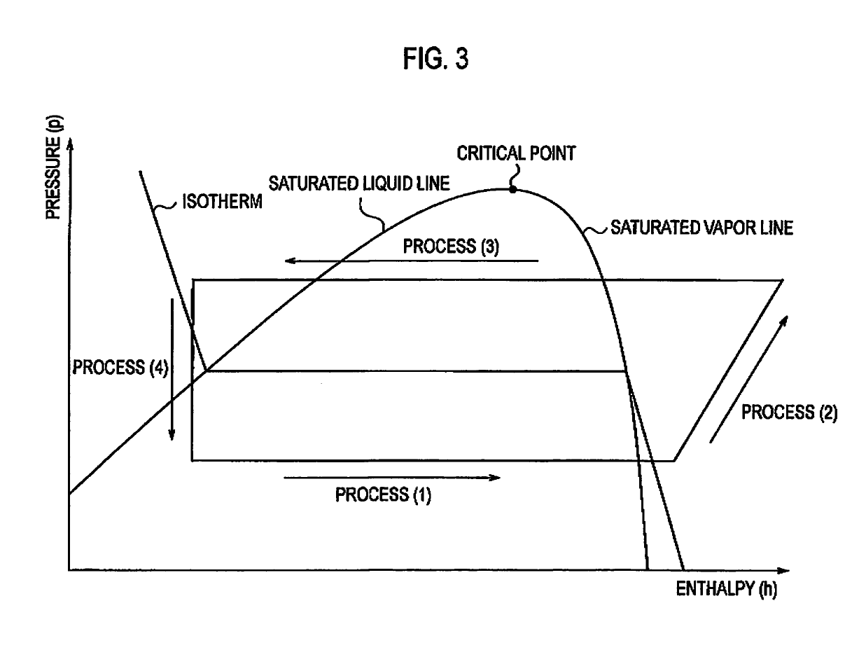

Here, description is here given taking a CO₂ refrigerant as an example of a refrigerant circulating in the refrigerant passage 360. With reference to FIG. 3, the circulation of the refrigerant is described as well. In FIG. 3, the vertical axis indicates the pressure (P) applied to the CO₂ refrigerant, and the horizontal axis indicates the enthalpy (h) of the CO₂ refrigerant. The isotherm is a line indicating combinations of the pressure (P) and the enthalpy (h) achieving a constant temperature. The saturated liquid line is a line indicating the boundary between a supercooled liquid and wet vapor. The saturated vapor line is a line indicating the boundary between wet vapor and superheated vapor. The critical point is a boundary between the saturated liquid line and the saturated vapor line.

The air passage 310 is the passage of the air. The optical elements (such as the liquid crystal panels 50, the compensation plates 51, the incident-side polarizing plates 52, the incident-side pre-polarizing plates 53, the output-side pre-polarizing plates 54, and the output-side polarizing plates 55) to be cooled are provided in the air passage 310.

The heat absorber 320 is a cooler configured to cool the air flowing in the air passage 310 with the refrigerant circulating in the refrigerant passage 360. In other words, in the heat absorber 320, the CO₂ refrigerant absorbs the heat of the air flowing in the air passage 310. In FIG. 3, as shown in Process (1), the absorption of the heat by the CO₂ refrigerant increases the enthalpy (h) with the pressure (P) kept constant.

The compressor 330 compresses the refrigerant having vaporized in the heat absorber 320. In FIG. 3, as shown in Process (2), the increase in the pressure (P) increases the degree of superheat of the CO₂ refrigerant.

The radiator 340 radiates the heat of the refrigerant having been compressed by the compressor 330. In FIG. 3, as shown in Process (3), the cooling of the CO₂ refrigerant decreases the enthalpy (h) with the pressure (P) kept constant. Thereby, the CO₂ refrigerant transitions to a supercooled liquid.

The decompressor 350 decompresses the refrigerant whose heat has been radiated by the radiator 340. In FIG. 3, as shown in Process (4), the pressure (P) decreases with the enthalpy (h) kept constant. Thereby, the CO₂ refrigerant transitions to web vapor.

Note that, FIG. 3 illustrates the case where the temperature of the environment where the projection display apparatus 100 is used is relatively low. In the case in which the temperature of the environment where the projection display apparatus 100 is used is relatively high, a supercritical cycle is observed in which the pressure in Process (3) where heat is radiated by the radiator 340 becomes not lower than a critical pressure.

The refrigerant passage 360 is a passage of the refrigerant. Specifically, the refrigerant passage 360 is a circular passage passing the heat absorber 320, the compressor 330, the radiator 340, and the decompressor 350.

The circulating fan 370 is a fan configured to circulate the air in the air passage 310. Specifically, the circulating fan 370 sends out the air having been cooled by the heat absorber 320 toward the optical elements.

Note that the cooling device 300 may include a temperature sensor 381 or a temperature sensor 382. The temperature sensor 381 is configured to detect the temperature of the air passing through the air passage 310. The temperature sensor 382 is configured to detect the temperature of the heat absorber 320 (cooler).

The temperature sensor 381 configured to detect the temperature of the air flowing in the air passage 310 may be located at any position in the air passage 310. The temperature sensor 381 is preferably located at a position farther away from the start points of the flow of the air which is to pass the heat absorber 320 and the optical elements, respectively. The temperature of the air changes greatly in each of the heat absorber 320 and the optical elements. For this reason, the variation in the air temperature is large at these start points. Accordingly, placing the temperature sensor 381 at the outlet of any of the heat absorber and the optical elements makes it difficult to detect an average air temperature.

In contrast, placing the temperature sensor 381 at the end point of the flow of the air having passed the heat absorber 320 and the optical elements ends facilitates the detection of an average air temperature because the air temperature is made uniform. In FIG. 2, the temperature sensor 381 is placed at a side where the air is sucked into the heat absorber 320. However, alternatively, the temperature sensor 381 may be placed at a side where the air is sucked into the optical elements, of course.

Meanwhile, the temperature sensor 382 configured to detect the temperature of the heat absorber 320 (cooler) is preferably located in a position at or downstream of the intermediate portion of the refrigerant passage. Of the refrigerant passage in the heat absorber 320, the temperature measured at the inlet of the refrigerant passage sometimes has a little to do with the air temperature in the air passage 310. For this reason, the inlet of the refrigerant passage is not preferable as a position for the temperature sensor 382 to indirectly detect the air temperature in the air passage 310.

In contrast, the temperature measured at the position at or downstream of the intermediate portion of the refrigerant passage has relatively a great deal to do with the air temperature in the air passage 310. Accordingly, the position at or downstream of the intermediate portion of the refrigerant passage is preferable as the position for the temperature sensor 382 to indirectly detect the air temperature in the air passage 310.

### (Configuration of Control Unit)

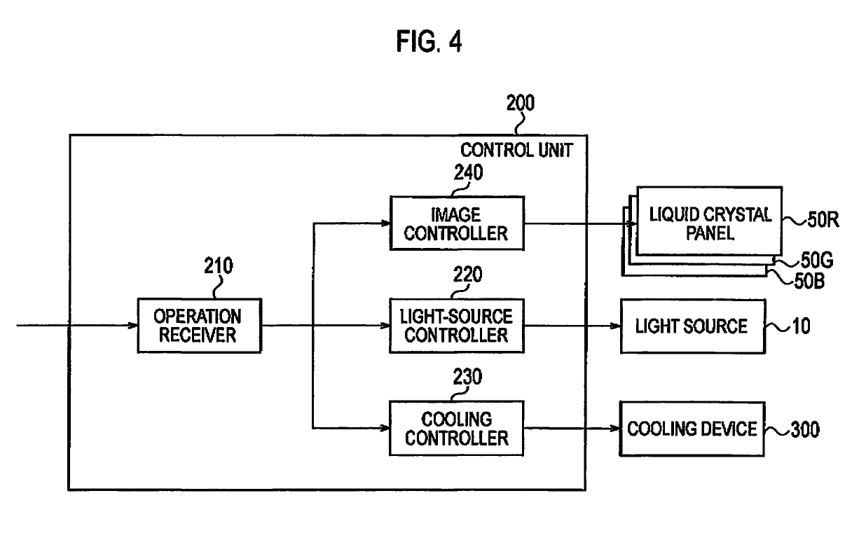

Hereinbelow, the configuration of the control unit according to the first embodiment is described with reference to the drawings. FIG. 4 is a diagram showing the control unit 200 according to the first embodiment.

It should be noted that, in the first embodiment, the light amount of light to be irradiated on each of the liquid crystal panels 50 (i.e., the incident-side polarizing plates 52) is set at a predetermined light amount in a normal operation state. The normal operation state is a state where the projection display apparatus 100 whose operation is in a stable condition projects image light.

As shown in FIG. 4, the control unit 200 includes an operation receiver 210, a light-source controller 220 (a light-amount controller), a cooling controller 230, and an image controller 240 (an optical-element controller).

The operation receiver 210 receives manipulation instructions from a manipulation I/F (not shown) and the like. The manipulation instructions include: operation start instructions to start the operation of the projection display apparatus 100; and operation termination instructions to terminate the operation of the projection display apparatus 100, for example. The operation start instructions include: an instruction to turn on the power source of the projection display apparatus 100; and an instruction to start the display of an image, for example. The operation termination instructions include: an instruction to cut off the power source; and an instruction to terminate the display of an image, for example.

The light-source controller 220 controls the light source 10. Specifically, the light-source controller 220 controls the power to be supplied to the light source 10. The light-source controller 220 may control an absolute amount of power to be supplied to the light source 10. The light-source controller 220 may control the power to be supplied to the light source 10 by means of pulses.

Here, the light-source controller 220 causes the light source 10 to emit light upon receipt of an operation start instruction. The light-source controller 220 controls the power to be supplied to the light source 10 upon receipt of the operation start instruction so that light having a smaller light amount than the predetermined light amount may be irradiated on each of the liquid crystal panels 50 (i.e., the incident-side polarizing plates 52 and the like).

To be more specific, the light-source controller 220 controls the power to be supplied to the light source 10 upon receipt of the operation start instruction so that the smaller power than a predetermined power may be supplied to the light source 10. Note that the predetermined power represents a power necessary for the light having the predetermined light amount to be irradiated on each of the liquid crystal panels 50 (i.e., the incident-side polarizing plates 52 and the like). Conceivable methods of controlling the power to be supplied to the light source 10 include: a method of controlling the power to be supplied to the light source 10 so that it may be reduced to a half of the predetermined power; and a method of controlling the power to be supplied to the light source 10 so that it may be reduced to “0,” for example.

In the following description, a period during which the light amount to be irradiated on each of the liquid crystal panels 50 (i.e., the incident-side polarizing plates 52) is reduced to be smaller than the predetermined light amount upon receipt of the operation start instruction is referred to as a “light-amount reduction period.” Examples of the light-amount reduction period include: (A1) a period which lasts until a predetermined length of time passes after the receipt of the operation start instruction; (A2) a period which lasts until the temperature detected by the temperature sensor 381 (the temperature of the air flowing in the air passage 310) falls below a predetermined temperature after the receipt of the operation start instruction; and (A3) a period which lasts until the temperature detected by the temperature sensor 382 (the temperature of the heat absorber 320) falls below a predetermined temperature after the receipt of the operation start instruction.

On the other hand, the light-source controller 220 causes the light source 10 to emit light even though receiving the operation termination instruction. In other words, the light source 10 keeps emitting the light even in the case of receiving the operation termination instruction. The light-source controller 220 controls the power to be supplied to the light source 10 upon receipt of the operation termination instruction so that light having a smaller light amount than a predetermined light amount may be irradiated on each of the liquid crystal panels 50 (i.e., the incident-side polarizing plates 52 and the like).

To be more specific, the light-source controller 220 controls the power to be supplied to the light source 10 upon receipt of the operation termination instruction so that light having a smaller light amount than a predetermined light amount may be supplied to the light source 10.

In the following description, a period during which light continues being irradiated on the optical elements to be cooled after the reception of an operation termination instruction is referred to as an “irradiation continuation period.” Examples of the irradiation continuing period include: (B1) a period which lasts until a predetermined length of time passes after the receipt of the operation termination instruction; (B2) a period which lasts until the temperature detected by the temperature sensor 381 (the temperature of the air flowing in the air passage 310) rises to a predetermined temperature after the receipt of the operation termination instruction; and (B3) a period which lasts until the temperature detected by the temperature sensor 382 (the temperature of the heat absorber 320) rises to a predetermined temperature after the receipt of the operation termination instruction.

The cooling controller 230 controls the cooling device 300. The cooling controller 230 in this embodiment immediately starts the operation of the cooling device 300 upon receipt of the operation start instruction. In other words, the cooling device 300 immediately starts the cooling of the air flowing in the air passage 310 upon receipt of the operation start instruction.

On the other hand, the cooling controller 230 immediately terminates the operation of the cooling device 300 upon receipt of the operation termination instruction. In other words, the cooling device 300 immediately terminates the cooling of the air flowing in the air passage 310 upon receipt of the operation termination instruction.

Nevertheless, even when terminating the operations of the heat absorber 320, the compressor 330, the radiator 340, and the decompressor 350 in the cooling device 300, the cooling controller 230 continues the operation of the circulating fan 370.

To be more specific, even when terminating the operation of the cooling device 300, the cooling controller 230 controls the circulating fan 370, and thus circulates the air flowing in the air passage 310. Note that the cooling controller 230 stops the operation of the circulating fan 370 after the irradiation continuation period ends.

The image controller 240 controls the liquid crystal panels 50 in response to the operation start instruction. For example, the image controller 240 controls an image to be displayed on the liquid crystal panels 50 on the basis of image data stored in a DVD reproduction device or a built-in memory.

Here, the image controller 240 controls the liquid crystal panels 50 so that the entire light emitted from the light source 10 may be transmitted through the respective output-side polarizing plates 55 during the light-amount reduction period. In other words, the image controller 240 controls the liquid crystal panels 50 so that a white image may be displayed on the screen.

The image controller 240 may control the liquid crystal panels 50 so that a specific color component light out of the red component light, the green component light, and the blue component light may be transmitted through the corresponding output-side polarizing plate 55. For example, the image controller 240 controls the liquid crystal panel 50B so that only the blue component light having light energy higher than those of any other component light may be transmitted through the output-side polarizing plate 55B.

Meanwhile, the image controller 240 controls the liquid crystal panels 50 in response to the operation termination instruction. The image controller 240 controls the liquid crystal panels 50 so that the entire light emitted from the light source 10 may be shielded by the respective output-side polarizing plates 55. In other words, the image controller 240 controls the liquid crystal panels 50 so that a black image may be displayed on the screen.

### (Start of Cooling of Optical Elements)

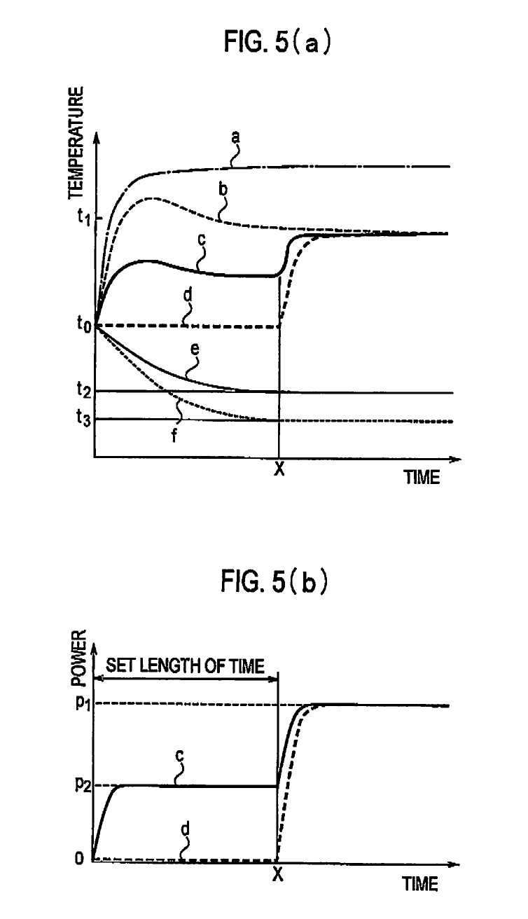

Hereinbelow, referring to the drawings, descriptions will be provided for the start of the cooling of the optical elements to be cooled according to the first embodiment. FIGS. 5(a) and 5(b) are diagrams for explaining the start of the cooling of the optical elements to be cooled according to the first embodiment. Incidentally, as described above, the optical elements to be cooled are the liquid crystal panels 50, the compensation plates 51, the incident-side polarizing plates 52, the incident-side pre-polarizing plates 53, the output-side pre-polarizing plates 54, and the output-side polarizing plates 55.

In FIG. 5(a), the vertical axis indicates the temperature of the optical elements or the like to be cooled, and the horizontal axis indicates the length of time having passed after the operation start instruction. The temperature t0 represents the temperature of the outside air outside the air passage 310 (room temperature, for example). The temperature t1 represents the upper limit of the range of the operating temperature allowable for the optical elements to be cooled (hereinafter, allowable temperature range).

In FIG. 5(b), the vertical axis indicates power to be supplied to the light source 10, and the horizontal axis indicates the length of time having passed after the operation start instruct. The power P1 represents the predetermined power necessary for light having the predetermined light amount to be irradiated on each of the liquid crystal panels 50 (i.e., the incident-side polarizing plates 52). The power P2 represents the power that is half of the predetermined power.

Here, in FIG. 5(a), the curve a shows the case where the cooling device 300 does not operate. The curves b to d each show the case where the cooling device 300 operates. The curve b shows the case where the predetermined power is supplied to the light source 10.

The curve c shows the case where the power that is half of the predetermined power is supplied to the light source 10 until the length of time X passes after the receipt of the operation start instruction (see the curve c in FIG. 5(b)). The curve d shows the case where no power is supplied to the light source 10 until the length of time X passes after the receipt of the operation start instruction (see the curve d in FIG. 5(b)).

The curve e indicates the temperature of the air flowing in the air passage 310. In other words, the curve e indicates the temperature detected by the temperature sensor 381. The curve f indicates the temperature of the heat absorber 320. In other words, the curve f indicates the temperature detected by the temperature sensor 382.

As the curve a to the curve d show, in the curve a and the curve b, the temperature of the optical elements to be cooled exceeds the upper limit of the allowable temperature range (temperature t1). In the curve b, in particular, the temperature of the optical elements exceeds the upper limit (temperature t1) of the allowable temperature range although the cooling device 300 operates.

In contrast, in the curve c and the curve d, the temperature of the optical elements to be cooled does not exceed the upper limit of the allowable temperature range (temperature t1).

Here, the aforementioned periods (A1) to (A3) are conceivable as the light-amount reduction period. The predetermined length of time and the predetermined temperature in the light-amount reduction period are determined on the basis of the previously-measured temperature change shown in FIG. 5(a) so that the temperature of the optical elements should not exceed the upper limit of the allowable temperature range (temperature t1).

To be more specific, in the case of using the period (A1) as the light-amount reduction period, the predetermined length of time is the length of time X; in the case of using the period (A2) as the light-amount reduction period, the predetermined temperature is the temperature t2; in the case of using the period (A3) as the light-amount reduction period, the predetermined temperature is the temperature t3.

### (Termination of Cooling of Optical Elements)

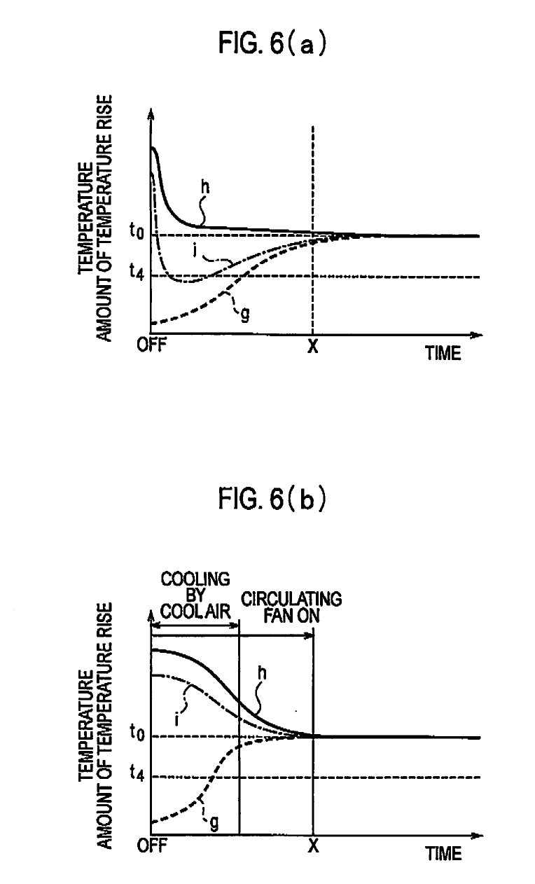

Hereinafter, referring to the drawings, descriptions will be provided for the termination of the cooling of the optical elements. FIGS. 6(a) and 6(b) are diagrams for explaining the termination of the cooling of the optical elements according to the first embodiment.

In FIGS. 6(a) and 6(b), the vertical axis indicates temperatures such as a cooling temperature, an amount of temperature rise, a temperature of the elements; and the horizontal axis indicates a length of time having passed after the operation termination instruction. The temperature t0 represents the temperature of the outside air outside the internal passage 310 (room temperature, for example). The temperature t4 represents the dew-point temperature of the outside air.

In FIG. 6(a) and FIG. 6(b), the curve g indicates the temperature of the air (cool air) flowing in the air passage 310, specifically, the temperature of the cool air blowing against the optical elements to be cooled. The curve h indicates the amount of temperature rise of the optical elements to be cooled which are heated by the irradiation of light. The curve i indicates the element temperature of the optical elements to be cooled. It should be noted that the temperature of the cool air, the amount of temperature rise, and the element temperature vary depending on the light amount irradiated on the optical elements to be cooled.

FIG. 6(a) shows the case where the light source 10 terminates the output of light simultaneously with the operation termination instruction. As shown in FIG. 6(a), the light source 10 immediately terminates the output of light in the case where the operation of the cooling device 300 is terminated (OFF state). The light amount irradiated on the optical elements thus decreases rapidly.

Since light from the light source 10 is no longer irradiated on the optical elements, the heating of the optical elements by the light emitted from the light source 10 is terminated, and the amount of temperature rise of the optical elements rapidly decreases. Moreover, the temperature of the cool air having been cooled when the cooling device 300 is in operation (ON state) slowly increases. Thereby, the element temperature rapidly decreases. Accordingly, the balance between the amount of temperature rise and the temperature of the cool air is lost. Thus, the element temperature falls below the dew-point temperature (temperature t4), and dew is formed in the optical elements.

To be more specific, although the air passage 310 is kept substantially hermetically sealed, some of the outside air enters the air passage 310. For this reason, if the element temperature falls below the dew-point temperature, dew may be formed in the optical element due to the outside air which have entered the air passage and comes into contact with the optical element. Incidentally, one may consider that, if the element temperature falls below 0 degree, frost may possibly be formed in the optical elements.

On the other hand, FIG. 6(b) shows the case where the light source 10 keeps emitting the like even in the case of receiving the operation termination instruction. As shown in FIG. 6(b), in the case where the operation of the cooling device 300 is terminated (OFF state), light having the smaller light amount than the predetermined light amount is emitted from the light source 10 during the irradiation continuation period.

Since the optical elements are irradiated with light from the light source 10, the optical elements are heated by the light emitted from the light source 10, and the amount of temperature rise of the optical elements slowly decreases. Moreover, the temperature of the cool air having been cooled when the cooling device 300 is in operation (ON state) slowly increases. On this occasion, the length of time for the temperature of the cool air flowing in the air passage 310 to return to the temperature of the outside air is shortened.

Thus, the rapid decrease in the element temperature is eased. Accordingly, the balance between the amount of temperature rise and the temperature of the cool air is never lost, and the element temperature never falls below the dew-point temperature (temperature t4). Consequently, the formation of dew or frost in the optical elements is inhibited.

In this respect, the aforementioned periods (B1) to (B3) are conceivable as the irradiation continuation period. The predetermined length of time and the predetermined temperature in the irradiation continuation period are determined on the basis of the previously-measured temperature change shown in FIG. 5(a) so that the element temperature should not fall below the dew-point temperature (temperature t4). In particular, the predetermined length of time and the predetermined temperature are preferably determined so that the element temperature should not fall below the temperature of the outside air.

To be more specific, in the case of using the period (B1) as the irradiation continuation period, the predetermined length of time is the length of time X; in the case of using the period (B2) as the irradiation continuation period, the temperature of the cool air blowing against the optical elements is calculated on the basis of the temperature measured by the temperature sensor 381, and the predetermined temperature is determined so that the temperature of the cool air should not exceed the temperature t4. Similarly, in the case of using the period (B3) as the irradiation continuation period, the temperature of the cool air blowing against the optical elements is calculated on the basis of the temperature measured by the temperature sensor 382, and the predetermined temperature is determined so that the temperature of the cool air should not exceed the temperature t4.

### (Operation-Effects)

In the first embodiment, the cooling device 300 (the heat absorber 320) starts the cooling of the air flowing through the air passage 310 upon receipt of the operation start instruction. The light-source controller 220 controls the power to be supplied to the light source 10 upon receipt of the operation start instruction so that the smaller power than the predetermined power may be supplied to the light source 10. Thereby, the temperature of the optical elements to be cooled can be inhibited from exceeding the upper limit of the allowable temperature range during the time until the projection display apparatus 100 comes into the normal operation state after the receipt of the operation start instruction.

In the first embodiment, the light-source controller 220 controls the power to be supplied to the light source 10 so that the smaller power than the predetermined power may be supplied to the light source 10 during the light-amount reduction period. Examples of the light-amount reduction period include: (A1) the period which lasts until the predetermined length of time passes after the receipt of the operation start instruction; (A2) the period which lasts until the temperature detected by the temperature sensor 381 falls below the predetermined temperature after the receipt of the operation start instruction; and (A3) the period which lasts until the temperature detected by the temperature sensor 382 falls below the predetermined temperature after the receipt of the operation start instruction. For this reason, it is possible to irradiate each of the liquid crystal panels 50 (i.e., the incident-side polarizing plates 52) with the light having the predetermined light amount at an appropriate timing while inhibiting the temperature of the optical elements to be cooled from exceeding the upper limit of the allowable temperature range.

In the first embodiment, the image controller 240 controls the liquid crystal panels 50 so that the entire light emitted from the light source 10 may be transmitted through the respective output-side polarizing plates 55 during the light-amount reduction period. For this reason, it is possible to suppress the temperature rise of each output-side polarizing plate 55 due to the shielding of light.

In the first embodiment, the image controller 240 controls the liquid crystal panel 50B so that only the blue component light having light energy higher than those of any other component light may be transmitted through the output-side polarizing plate 55B during the light-amount reduction period. For this reason, it is possible to suppress the damage on the output-side polarizing plate 55B due to the shielding of light.

In the first embodiment, the cooling device 300 (the cooling controller 230) terminates the cooling of the air flowing in the air passage 310 upon receipt of the operation termination instruction. On the other hand, the light source 10 keeps emitting the light even in the case of receiving the operation termination instruction. With this configuration, the optical elements are heated by the light from the light source 10. This shortens the length of time for the temperature of the cool air blowing against the optical elements to be cooled to return to the temperature of the outside air, and eases a rapid drop of the element temperature. Accordingly, the balance between the amount of temperature rise and the temperature of the cool air is never lost. Thus, the element temperature never falls below the dew-point temperature (temperature and it is consequently possible to inhibit the formation of dew or frost in the optical elements.

In the first embodiment, the light-source controller 220 controls the power to be supplied to the light source 10 so that the smaller power than the predetermined power may be supplied to the light source 10 during the irradiation continuation period. Examples of the irradiation continuation period include: (B1) the period which lasts until the predetermined length of time passes after the receipt of the operation termination instruction; (B2) the period which lasts until the temperature detected by the temperature sensor 381 (the temperature of the air flowing in the air passage 310) rises to the predetermined temperature after the receipt of the operation termination instruction; and (B3) the period which lasts until the temperature detected by the temperature sensor 382 (the temperature of the heat absorber 320) rises to the predetermined temperature after the receipt of the operation termination instruction. Accordingly, the element temperature never falls below the dew-point temperature during the irradiation continuation period. Consequently, it is possible to inhibit the formation of dew in the optical element.

In the first embodiment, upon receipt of the operation termination instruction, the light-source controller 220 performs control such that light having the smaller light amount than the predetermined light amount may be irradiated on the optical elements. This makes it possible to inhibit the temperature of the optical elements from exceeding the upper limit of the allowable temperature range, and to reduce the light amount emitted from the light source 10. Accordingly, the light amount can be reduced with a simple configuration, without the need for a special configuration for controlling the light amount. Further, the lifetime of the lamp can be prevented from being shortened.

In the first embodiment, even after the termination of the operation of the cooling device 300, the cooling controller 230 controls the circulating fan 370, and thus circulates the air flowing in the air passage 310. This makes spots of different temperatures less likely to be formed in the air passage 310, and thus makes it possible to keep constant the temperature in the air passage 310.

Further, since the optical elements are heated by the light from the light source 10 even after the termination of the operation of the cooling device 300, the circulation of the air flowing in the air passage 310 shortens the length of time for the temperature of the cool air blowing against the optical elements to be cooled to return to the temperature of the outside air.

### Second Embodiment

Hereinbelow, a second embodiment is described with reference to the drawings. Hereinafter, descriptions are given mainly of points different between the first embodiment and the second embodiment.

Specifically, in the first embodiment, the light amount irradiated on the optical elements to be cooled is controlled by means of the power supplied to the light source 10. On the other hand, in the second embodiment, the light amount irradiated on the optical elements to be cooled is controlled by a light-amount iris unit formed of a light-shielding member.

### (Configuration of Projection Display Apparatus)

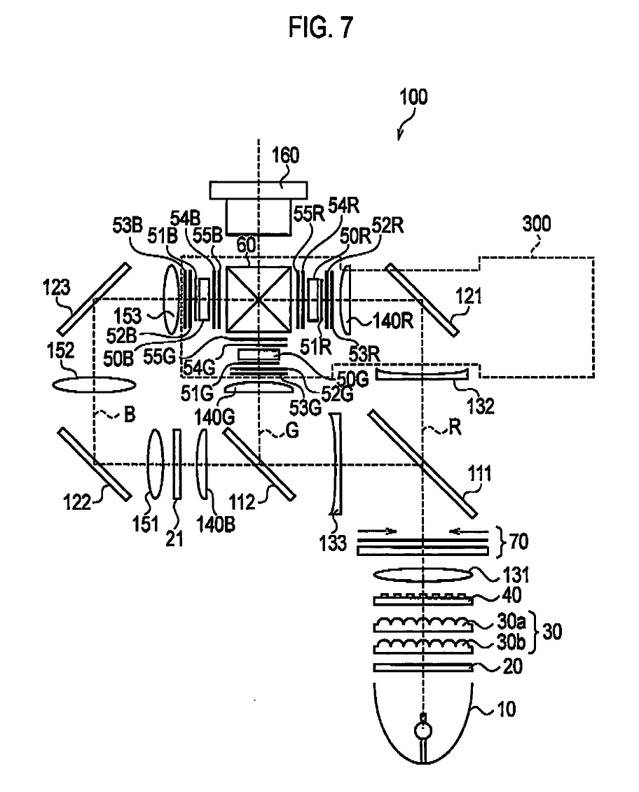

Hereinafter, referring to the drawings, descriptions will be provided for a configuration of a projection display apparatus according to a second embodiment. FIG. 7 is a diagram showing the projection display apparatus 100 according to the second embodiment. In FIG. 7, configuration parts which are the same as those shown in FIG. 1 are denoted by the same reference numerals.

As shown in FIG. 7, the projection display apparatus 100 includes a light-amount iris unit 70 in addition to the configuration parts shown in FIG. 1.

The light-amount iris unit 70 is provided between the light source 10 and the liquid crystal panels 50. The light-amount iris unit 70 is formed of a light-shielding member. The light-amount iris unit 70 is configured to be capable of changing the amount of shielding of light emitted from the light source 10 (reduction amount). For example, the light-amount iris unit 70 is formed of a shutter or the like. The light-amount iris unit 70 thus adjusts the light amount to be irradiated on each of the liquid crystal panels 50 (i.e., the incident-side polarizing plates 52).

### (Configuration of Control Unit)

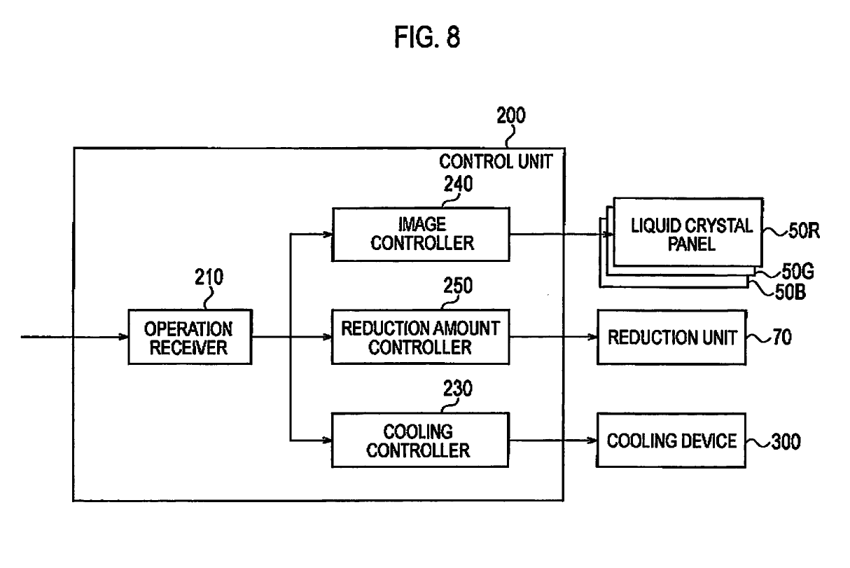

Hereinafter, referring to the drawings, descriptions will be provided for the configuration of a control unit according to the second embodiment. FIG. 8 is a block diagram showing the control unit 200 according to the second embodiment. In FIG. 8, configuration parts which are the same as those shown in FIG. 4 are denoted by the same reference numerals.

As shown in FIG. 8, the control unit 200 includes a reduction amount controller 250 in lieu of the light-source controller 220.

The reduction amount controller 250 controls the light-amount iris unit 70. To be specific, the reduction amount controller 250 controls the amount of shielding of light emitted from the light source 10 (reduction amount).

In this respect, the reduction amount controller 250 controls the reduction amount of the light-amount iris unit 70 upon receipt of the operation start instruction or the operation termination instruction so that light having the smaller light amount than the predetermined light amount may be irradiated on each of the liquid crystal panels 50 (i.e., the incident-side polarizing plates 52). To be specific, the reduction amount controller 250 controls the reduction amount of the light-amount iris unit 60 so that the light emitted from the light source 10 may have a reduction amount larger than a predetermined reduction amount. Incidentally, the predetermined reduction amount is a reduction amount with which light having the predetermined light amount is irradiated on each of the liquid crystal panels 50 (i.e., the incident-side polarizing plates 52). Alternatively, the predetermined reduction amount may be “0.”

Conceivable methods of controlling the reduction amount of the light-amount iris unit 60 include: a method in which half of the light emitted from the light source 10 is shielded; and a method in which the entire light emitted from the light source 10 is shielded, for example.

In the second embodiment, the cooling device 300 (the heat absorber 320) starts the cooling the air flowing through the air passage 310 upon receipt of the operation start instruction. The reduction amount controller 250 controls the reduction amount of the light-amount iris unit 60 upon receipt of the operation start instruction so that the light emitted from the light source 10 may have the reduction amount larger than the predetermined reduction amount. Accordingly, like in the first embodiment, the temperature of the optical elements to be cooled can be inhibited from exceeding the upper limit of the allowable temperature range during the time until the projection display apparatus 100 comes into the normal operation state after the receipt of the operation start instruction.

In the second embodiment, the reduction amount controller 250 controls the reduction amount of the light-amount iris unit 70 upon receipt of the operation termination instruction so that the light emitted from the light source 10 may have the reduction amount larger than the predetermined reduction amount. Thus, like in the first embodiment, the temperature of the optical elements to be cooled can be inhibited from exceeding the upper limit of the allowable temperature range during the irradiation continuation period (for example, the period which lasts until the predetermined length of time passes after the receipt of the operation termination instruction).

### Third Embodiment

Hereinafter, referring to the drawings, descriptions will be provided for a third embodiment. Hereinafter, descriptions will be given mainly of points different between the first embodiment and the third embodiment.

Specifically, in the first embodiment, the projection display apparatus 100 includes the single light source 10. On the other hand, in the third embodiment, the projection display apparatus 100 includes multiple light sources 10.

### (Configuration of Projection Display Apparatus)

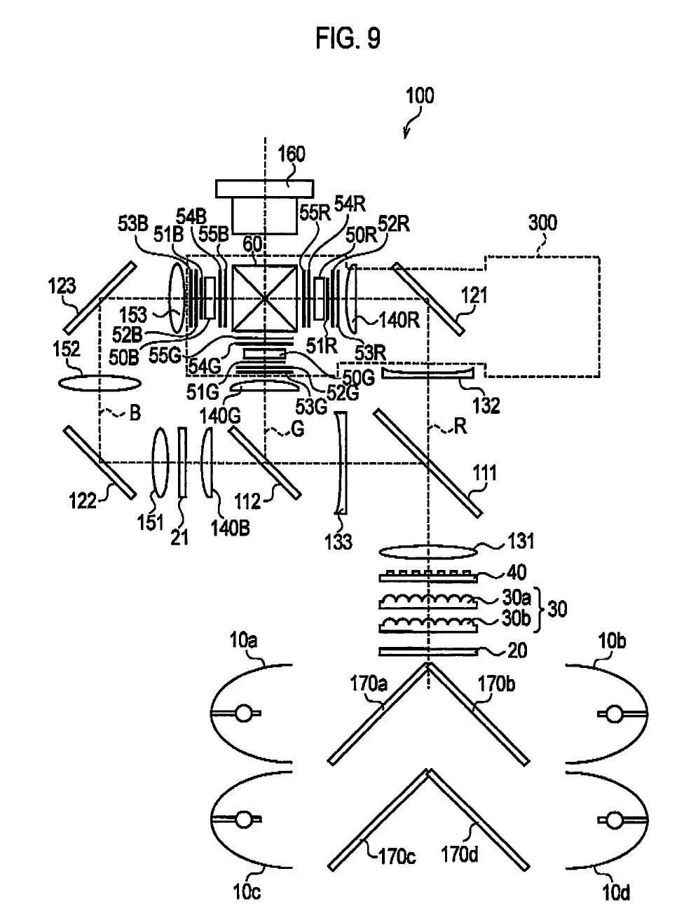

Hereinafter, referring to the drawings, descriptions will be provided for a configuration of the projection display apparatus according to the third embodiment. FIG. 9 is a diagram showing the projection display apparatus 100 according to the third embodiment. In FIG. 9, configuration parts which are the same as those shown in FIG. 1 are denoted by the same reference numerals.

As shown in FIG. 9, the projection display apparatus 100 includes the multiple light sources 10 (light sources 10a to 10d). The projection display apparatus 100 also includes multiple reflection mirrors 170 (reflection mirrors 170a to 170d) in addition to the configuration shown in FIG. 1.

Examples of the light sources 10a to 10d include a UHP lamp configured to emit white light, like the light source 10 described above. The reflection mirrors 170a to 170d reflects light emitted from the light sources 10a to 10d toward the fly-eye lens unit 30, respectively.

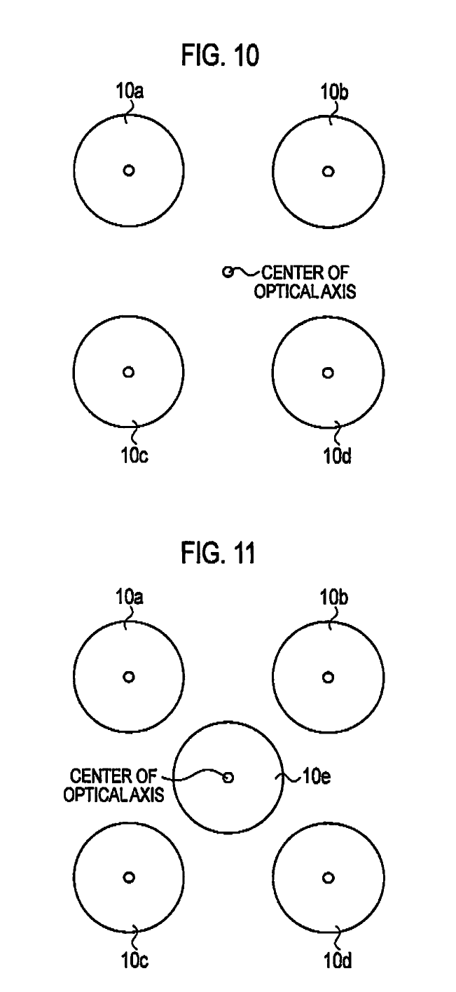

FIG. 10 is a conceptual diagram showing the arrangement of the light sources 10a to 10d according to the third embodiment. FIG. 10 shows how light beams emitted from the light sources 10a to 10d are arranged after reflected by the reflection mirrors 170a to 170d. As shown in FIG. 10, the light beams emitted from the light sources 10a to 10d are placed around the center of the optical axis.

In this respect, the light-source controller 220 described above controls the number of light sources 10 to be lit during the light-amount reduction period. It should be noted that, in the third embodiment, the predetermined light amount in the normal operation state is the total light amount emitted from all the light sources 10a to 10d.

To be specific, upon receipt of the operation start instruction, the light-source controller 220 starts to supply power to some of the multiple light sources 10, and withholds the start of the supply of the power to the others of the light sources 10. In other words, the light-source controller 220 reduces the number of light sources 10 to be lit during the light-amount reduction period. For example, during the light-amount reduction period, the light-source controller 220 lights only two of the light sources 10, and withholds the lighting of the other light sources 10.

In this way, the light-source controller 220 performs control such that light beams emitted from some of the light sources 10 may be irradiated on the optical elements to be cooled later in time than light beams emitted from the others of the light sources 10.

Here, the light sources 10 to be lit during the light-amount reduction period are preferably symmetrical with respect to the center of the optical axis. For example, the light-source controller 220 lights the light source 10a and the light source 10d, and withholds the lighting of the light source 10b and the light source 10c. Alternatively, the light-source controller 220 lights the light sources 10b and the light source 10c, and withholds the lighting of the light source 10a and the light source 10d.

Further, the total light amount emitted from some of the light sources 10 is preferably symmetrical to the total light amount emitted from the others of the light sources 10.

Meanwhile, the light-source controller 220 controls the number of light sources 10 to be lit during the irradiation continuation period. Specifically, upon receipt of the operation termination instruction, the light-source controller 220 terminates the supply of the power to some of the multiple light sources 10, and maintains power the supply of the others of the light sources 10. In other words, the light-source controller 220 reduces the number of light sources 10 to be lit during the irradiation continuation period. For example, during the irradiation continuation period, the light-source controller 220 lights only two of the light sources 10, and withholds the lighting of the other light sources 10.

In this way, the light-source controller 220 performs control such that light beams emitted from some of the light sources 10 may be irradiated on the optical elements to be cooled longer in time than light beams emitted from the others of the light sources 10.

### (Operation-Effects)

According to the third embodiment, upon receipt of the operation start instruction, the light-source controller 220 starts to supply the power to some of the multiple light sources 10, and withholds the start of the supply of the power to the others of the light sources 10. For this reason, like in the first embodiment, it is possible to inhibit the temperature of the optical elements to be cooled from exceeding the upper limit of the allowable temperature range during the period until the projection display apparatus 100 comes into the normal operation state after the receipt of the operation start instruction.

Further, the light sources 10 to be lit during the light-amount reduction period are symmetrical with respect to the center of the optical axis. This makes it possible to suppress color unevenness which may occur on the screen during the light-amount reduction period.

According to the third embodiment, upon receipt of the operation termination instruction, the light-source controller 220 terminates the supply of the power to some of the multiple light sources 10, and maintains the supply of the power to the others of the light sources 10. Accordingly, like in the first embodiment, the temperature of the optical elements to be cooled can be inhibited from exceeding the upper limit of the allowable temperature range during the irradiation continuation period (for example, the period which lasts until the predetermined length of time passes after the receipt of the operation termination instruction).

### Modification of Third Embodiment

Hereinbelow, a modification of the third embodiment is described with reference to FIG. 11. In the modification of the third embodiment, the projection display apparatus 100 includes multiple light sources 10 (light sources 10a to 10e). FIG. 11 is a conceptual diagram showing the arrangement of the light sources 10a to 10e according to the modification of the third embodiment.

The following orders are conceivable as the order that the light sources 10a to 10e are lit upon receipt of the operation start instruction in the above case. It should be noted that all the light sources 10a to 10e are turned off.

(1) Case where Light Sources are Lit in Two Phases

As the first phase, the light-source controller 220 lights the light source 10a, the light source 10d, and the light source 10e. As the second phase, the light-source controller 220 lights the light source 10b and the light source 10c.

Otherwise, as the first phase, the light-source controller 220 lights the light source 10b, the light source 10c, and the light source 10e. As the second phase, the light-source controller 220 lights the light source 10a and the light source 10d.

(2) Case where Light Sources are Lit in Three Phases

As the first phase, the light-source controller 220 lights the light source 10e. As the second phase, the light-source controller 220 lights the light source 10a and the light source 10d. As the third phase, the light-source controller 220 lights the light source 10b and the light source 10c.

Otherwise, as the first phase, the light-source controller 220 lights the light source 10e. As the second phase, the light-source controller 220 lights the light source 10b and the light source 10c. As the third phase, the light-source controller 220 lights the light source 10a and the light source 10d.

It should be noted that the first phase and the second phase may be swapped, or that the first phase and the third phase may be swapped. It should also be noted that the light sources 10a to 10e may be turned off in any arbitrary order upon receipt of the operation termination instruction.

### Fourth Embodiment

Hereinafter, referring to the drawings, descriptions will be provided for a fourth embodiment. The fourth embodiment is an embodiment obtained by combining the second embodiment and the third embodiment together.

### (Configuration of Projection Display Apparatus)

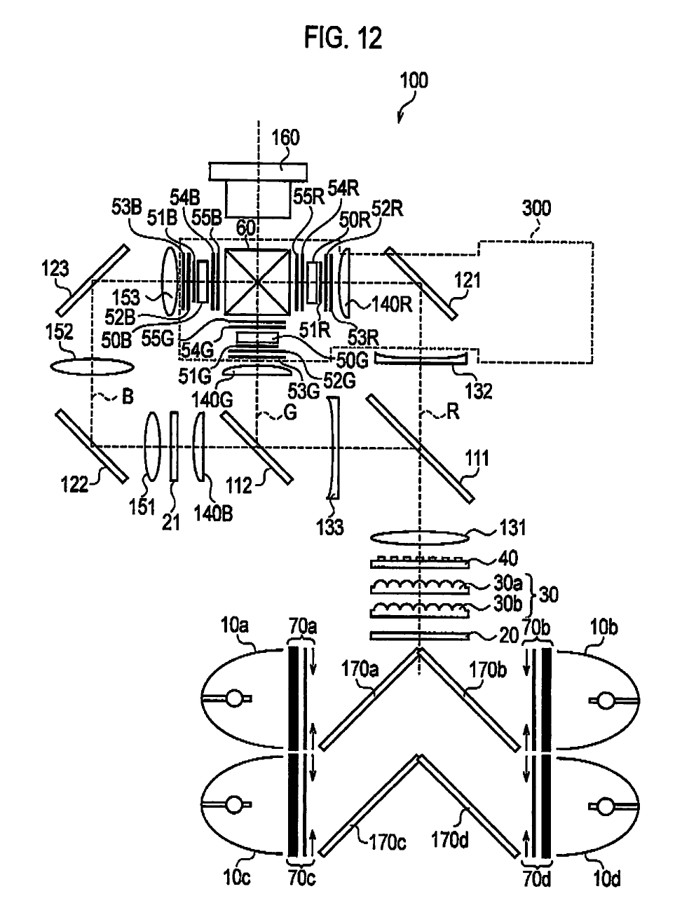

Hereinafter, referring to the drawing, descriptions will be provided for a configuration of a projection display apparatus according to the fourth embodiment. FIG. 12 is a diagram showing the projection display apparatus 100 according to the fourth embodiment. In FIG. 12, configuration parts which are the same as those shown in FIG. 1, FIG. 6 and FIG. 8 are denoted by the same reference numerals.

As shown in FIG. 12, the projection display apparatus 100 includes multiple light-amount iris units 70 (light-amount iris units 70a to 70d).

The light-amount iris units 70a to 70d are provided at the light-outgoing sides of the light sources 10a to 10d, respectively. The light-amount iris units 70a to 70d are each formed of a light-shielding member as in the case of the light-amount iris unit 70 described above. The light-amount iris units 70a to 70d are configured to be capable of changing the amounts of shielding of light emitted from the light sources 10a to 10d (reduction amounts), respectively.

In this respect, the reduction-amount controller 250 described above controls the reduction amounts of the respective light-amount iris units 70a to 70d during the light-amount reduction period. It should be noted that, in the fourth embodiment, the predetermined light amount in the normal operation state is the total light amount emitted from all the light sources 10a to 10d.

To be specific, upon receipt of the operation start instruction, the reduction amount controller 250 does not shield light beams emitted from some of the multiple light sources 10 while shielding all the light beams emitted from the others of the light sources 10. In other words, the reduction amount controller 250 allows only the light beams emitted from some of the light sources 10 to reach the liquid crystal panels 50 during the light-amount reduction period. For example, during the light-amount reduction period, the reduction amount controller 250 allows light beams emitted from two of the light sources 10 to reach the liquid crystal panels 50 while not allowing light beams emitted from the other light sources 10 to reach the liquid crystal panels 50.

The light sources 10 to cause light beams reaching the liquid crystal panels 50 during the light-amount reduction period to go out are preferably symmetrical with respect to the center of the optical axis, like in the third embodiment.

Meanwhile, the reduction amount controller 250 controls reduction amounts of the light-amount iris units 70a to 70d during the irradiation continuation period.

To be specific, upon receipt of the operation termination instruction, the reduction amount controller 250 does not shield light beams emitted from some of the multiple light sources 10 while shielding all the light beams emitted from the others of the light sources 10. In other words, the reduction amount controller 250 allows only the light beams emitted from some of the light sources 10 to reach the liquid crystal panels 50 during the irradiation continuation period. For example, during the irradiation continuation period, the reduction amount controller 250 allows light beams emitted from two of the light sources 10 to reach the liquid crystal panels 50 while not allowing light beams emitted from the other light sources 10 to reach the liquid crystal panels 50.

### (Operation-Effects)

In the fourth embodiment, upon receipt of the operation start instruction, the reduction amount controller 250 does not shield the light beams emitted from some of the multiple light sources 10 while shielding all the light beams emitted from the others of the light sources 10. For this reason, like in the first embodiment, it is possible to inhibit the temperature of the optical elements to be cooled from exceeding the upper limit of the allowable temperature range during the period until the projection display apparatus 100 comes into the normal operation state after the reception of the operation start instruction.

Further, the light sources 10 to cause light beams reaching the liquid crystal panels 50 during the light-amount reduction period to go out are symmetrical with respect to the center of the optical axis. For this reason, it is possible to suppress color unevenness which may occur on the screen during the light-amount reduction period.

In the fourth embodiment, upon receipt of the operation termination instruction, the reduction amount controller 250 does not shield the light beams emitted from some of the multiple light sources 10 while shielding all the light beams emitted from the others of the light sources 10. For this reason, like in the first embodiment, it is possible to inhibit the temperature of the optical elements to be cooled from exceeding the upper limit of the allowable temperature range during the irradiation continuation period (for example, the period which lasts until the predetermined length of time passes after the reception of the operation termination instruction).

### Fifth Embodiment

Hereinafter, referring to the drawings, descriptions will be provided for a fifth embodiment. Hereinafter, descriptions will be given of points different between the first embodiment and the fifth embodiment.

Specifically, in the second embodiment, the light emitted from the light source 10 is shielded by the polarizing plates (for example, the incident-side polarizing plates 52, the incident-side pre-polarizing plates 53, the output-side polarizing plates 55, and the output-side pre-polarizing plates 54). On the other hand, in the second embodiment, the light emitted from the light source 10 is shielded by a light-shielding shutter 80 formed of a light-shielding member.

### (Configuration of Projection Display Apparatus)

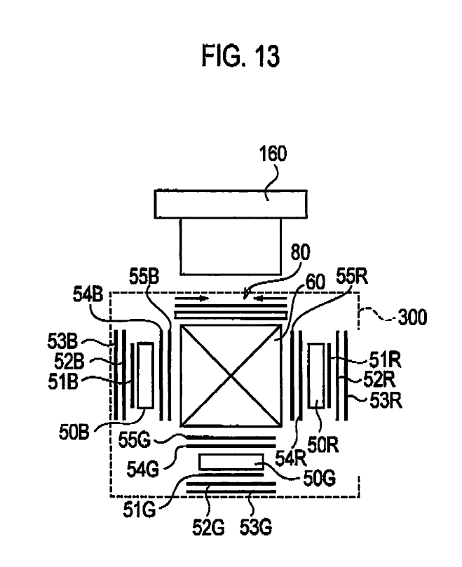

Hereinafter, referring to the drawing, descriptions will be provided for a configuration of a projection display apparatus according to the fifth embodiment. FIG. 13 is an enlarged diagram showing a cross dichroic prism 60 and its vicinity according to the fifth embodiment. Incidentally, in FIG. 13, configuration parts which are the same as those shown in FIG. 1 will be denoted by the same reference numerals.

As shown in FIG. 13, the projection display apparatus 100 includes the light-shielding shutter 80 in addition to the configuration shown in FIG. 2.

The light-shielding shutter 80 is provided between the cross dichroic prism 60 and the projection lens unit in the air passage 310. The light-shielding shutter 80 shields light emitted from the cross dichroic prism 60.

Note that, although the light-shielding shutter 80 is provided between the cross dichroic prism 60 and the projection lens unit in the air passage 310, the light-shielding shutter 80 may be provided between the cross dichroic prism 60 and the projection lens unit outside the air passage 310.

### (Configuration of Control Unit)

Hereinafter, referring to the drawing, descriptions will be provided for a configuration of a control unit according to the second embodiment.

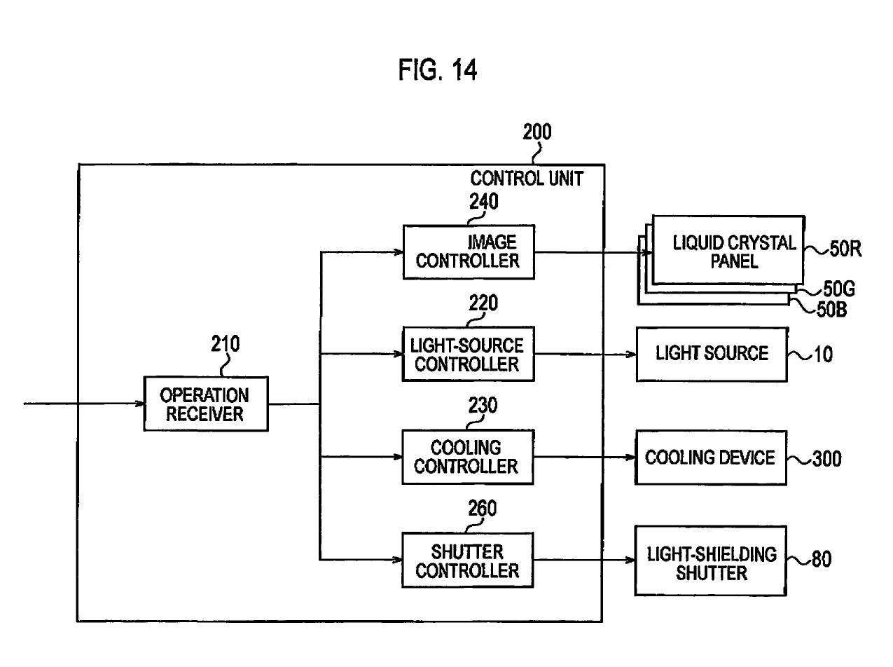

FIG. 14 is a block diagram showing the control unit 200 according to the second embodiment. In FIG. 14, configuration parts which are the same as those shown in FIG. 4 will be denoted by the same reference numerals.

As shown in FIG. 14, the control unit 200 includes a shutter controller 260. Note that the image controller 240 (the optical-element controller) controls the liquid crystal panels 50 so that light emitted from the light source 10 may be transmitted through the polarizing plates (for example, the output-side pre-polarizing plates 54 and the output-side polarizing plates 55).

The shutter controller 260 controls the light-shielding shutter 80 so that light emitted from the cross dichroic prism 60 (the liquid crystal panels 50) may be shielded by the light-shielding shutter 80. In other words, the light-shielding shutter 80 shields the light emitted from the cross dichroic prism 60 upon receipt of the operation termination instruction.

### (Operation-Effects)

In the fifth embodiment, the light source 10 keeps emitting light even in the case of receiving the operation termination instruction. The light emitted from the light source 10 is transmitted through the optical elements to be cooled, and then shielded by the light-shielding shutter 80 provided in the air passage 310. With this configuration, the optical elements are heated by the light from the light source 10. This shortens the length of time for the temperature of the cool air blowing against the optical elements to be cooled to return to the temperature of the outside air, and eases the rapid decrease in the element temperature. Accordingly, the balance between the amount of temperature rise and the temperature of the cool air is never lost, and the element temperature never falls below the dew-point temperature (temperature t4). Consequently, it is possible to inhibit the formation of dew or frost in the optical elements.

In the fifth embodiment, the light-shielding shutter 80 is provided between the cross dichroic prism 60 and the projection lens unit in the air passage 310. Accordingly, the light-shielding shutter 80 is heated by the light emitted from the light source 10. This shortens the length of time for the temperature of the air flowing in the air passage 310 (the temperature in the air passage 310) to return to the temperature of the outside air.

In the fifth embodiment, the light emitted from the cross dichroic prism 60 (the liquid crystal panels 50) is shielded by the light-shielding shutter 80. In other words, no light is projected on the screen after the operation termination instruction. Accordingly, the user is no longer made to feel as if the operation of the projection display apparatus 100 did not ended.

### Sixth Embodiment

Hereinafter, referring to the drawing, descriptions will be provided for a sixth embodiment. Hereinafter, descriptions will be given of points different between the first embodiment and the fifth embodiment.

In the first embodiment, the liquid crystal panels 50 are used as the light modulation elements. The optical elements to be cooled are the liquid crystal panels 50, the compensation plates 51, the incident-side polarizing plates 52, the incident-side pre-polarizing plates 53, the output-side pre-polarizing plates 54, and the output-side polarizing plates 55.

On the other hand, in the sixth embodiment, a two-dimensional scanning mirror is used as a light modulation element. In lieu of the liquid crystal panels 50, the two-dimensional scanning mirror joins the optical elements to be cooled.

### (Configuration of Projection Display Apparatus)

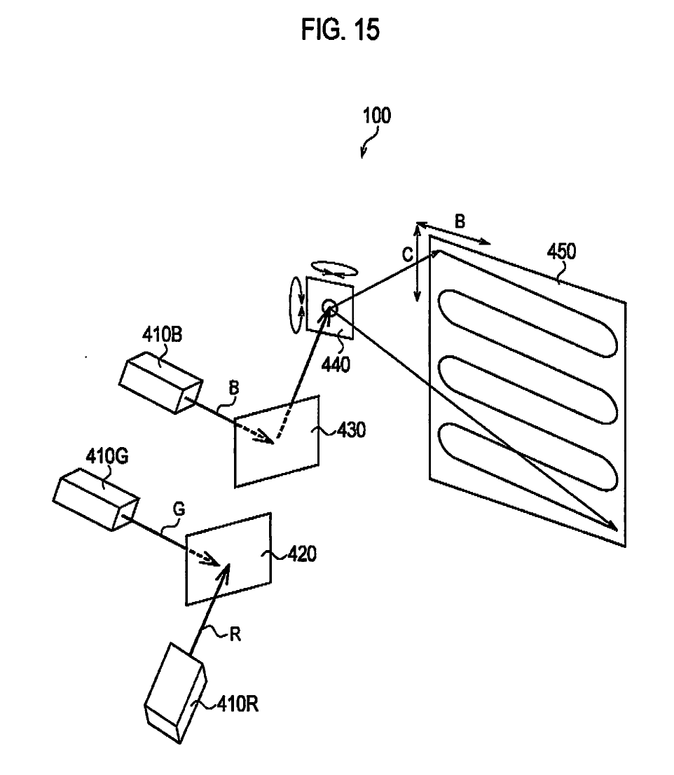

Hereinafter, referring to the drawing, descriptions will be provided for a projection display apparatus 100 according to the sixth embodiment. FIG. 15 is a diagram showing the projection display apparatus 100 according to the sixth embodiment.

As shown in FIG. 15, the projection display apparatus 100 includes a red light source 410R, a green light source 410G, a blue light source 410B, a dichroic mirror 420, a dichroic mirror 430, and a two-dimensional scanning mirror 440.

The red light source 410R is a laser light source configured to cause red component light to go out. The green light source 410G is a laser light source configured to cause green component light to go out. The blue light source 410B is a laser light source configured to cause blue component light to go out.

The dichroic mirror 420 transmits the red component light emitted from the red light source 410R, and reflects the green component light emitted from the green light source 410G.

The dichroic mirror 430 transmits the red component light and the green component light both emitted from the dichroic mirror 420, and reflects the blue component light emitted from the blue light source 410B.

In other words, the dichroic mirror 420 and the dichroic mirror 430 combines the red component light, the green component light, and the blue component light together.

The two-dimensional scanning mirror 440 scans the combined light (image light) emitted from the dichroic mirror 430 on a screen 450. Specifically, the two-dimensional scanning mirror 440 performs the operation of scanning the combined light (image light) on the screen 450 in the B direction (horizontal direction). Further, the two-dimensional scanning mirror 440 repeats the horizontal scanning in the C direction (vertical direction).

In the sixth embodiment, the two-dimensional scanning mirror 440 is placed in the air passage 310 provided in the cooling device 300. In other words, the two-dimensional scanning mirror 440 is one of the optical elements to be cooled.

### Seventh Embodiment

Hereinafter, referring to the drawing, descriptions will be provided for a seventh embodiment. Hereinafter, descriptions will be given mainly of points different between the first embodiment and the 6th embodiment.

In the first embodiment, the liquid crystal panels 50 are used as the light modulation elements. The optical elements to be cooled are the liquid crystal panels 50, the compensation plates 51, the incident-side polarizing plates 52, the incident-side pre-polarizing plates 53, the output-side pre-polarizing plates 54, and the output-side polarizing plates 55.

On the other hand, in the seventh embodiment, a one-dimensional scanning mirror is used as a light modulation element. In lieu of the liquid crystal panels 50, the one-dimensional scanning mirror joins the optical elements to be cooled.

### (Configuration of Projection Display Apparatus)

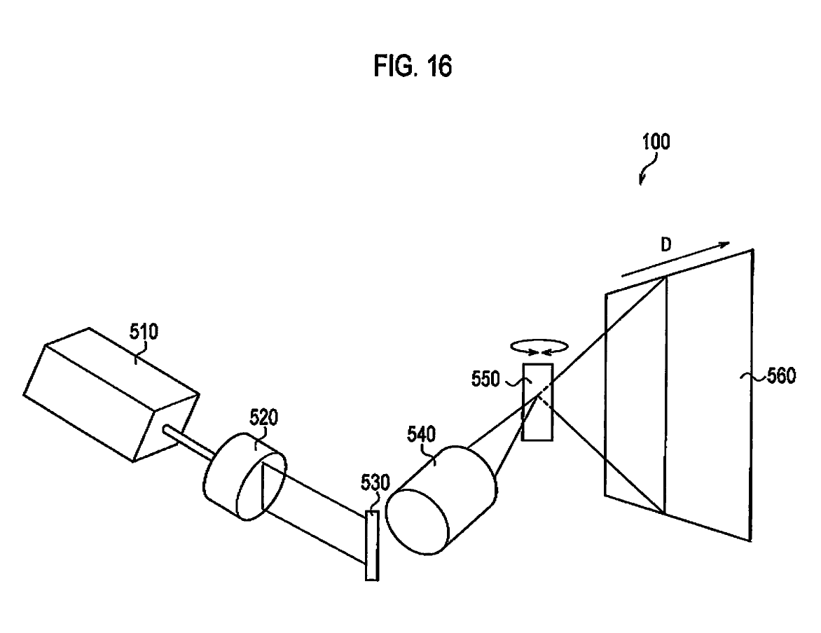

Hereinafter, referring to the drawing, descriptions will be provided for a projection display apparatus according to the seventh embodiment. FIG. 16 is a diagram showing the projection display apparatus 100 according to the seventh embodiment.

As shown in FIG. 16, the projection display apparatus 100 includes a light source 510, a lens 520, a linear optical element 530, a lens 540 and a one-dimensional scanning mirror.

The light source 510 is a laser light source configured to cause laser light to go out. The lens 520 condenses the laser light going out the light source 510 on the linear optical element 530.

The linear optical element 530 has a linear shape, and modulates the laser light emitted from the light source 510. The lens 540 condenses the linear light emitted from the linear optical element 530 on the one-dimensional scanning mirror 550.

The one-dimensional scanning mirror 550 scans the linear light emitted from the linear optical element 530 on a screen 560. Specifically, the one-dimensional scanning mirror 550 scans the linear light on the screen 560 in the D direction (horizontal direction).

In the seventh embodiment, the one-dimensional scanning mirror 550 is placed in the air passage 310 provided in the cooling device 300. In other words, the one-dimensional scanning mirror 550 is one of the optical elements to be cooled.

Note that the projection display apparatus 100 may include the light source 510 to the one-dimensional scanning mirror 550 for each of red, green, and blue. In this case, component light beams of the respective colors are superimposed on the screen 560 to form an image on the screen 560.

### Other Embodiments

As described above, the details of the present invention have been disclosed by using the embodiments of the present invention. However, it should not be understood that the description and drawings which constitute part of this disclosure limit the present invention. From this disclosure, various alternative embodiments, examples, and operation techniques will be easily found by those skilled in the art.

For example, the temperature sensor 382 may detect the temperature of the refrigerant flowing in the refrigerant passage 360. The irradiation continuation period may be a length of time for the temperature (the temperature of the refrigerant) detected by the temperature sensor 382 to increase to a predetermined temperature after receipt of the operation termination instruction.

Similarly, the temperature sensor 382 may detect the temperature of the refrigerant flowing in the refrigerant passage 360. The light-amount reduction period may be a period for the temperature (the temperature of the refrigerant) detected by the temperature sensor 382 to fall below a predetermined temperature.

In the above-described embodiments, the cooling device 300 is formed of the heat absorber 320, the compressor 330, the radiator 340, the decompressor 350, and the like. However, the configuration of the cooling device 300 is not limited to this. The cooling device 300 may include a Peltier device as a cooler configured to cool the air flowing through the air passage 310.

In the above-described embodiments, examples of the operation termination instruction include: an instruction to cut off the power supply; and an instruction to terminate the display of an image. However, the embodiments are not limited to this. For example, a case is conceivable where the power supply is forcibly stopped due to a trouble such as a blackout. In this case, no power is supplied to the projection display apparatus or the cooling device. For this reason, there is no means for heating the air in the air passage immediately after the cooling by the cooling device is stopped. It may induce the formation of dew in the optical elements to be cooled.

To cope with this, the projection display apparatus preferably includes charging means configured to supply power for driving heating means even if the power supply is forcibly stopped. Specifically, the projection display apparatus includes the charging means such as an UPS, a capacitor, or a battery, and drives the light source(s) by means of power supplied from the charging means when the power supply is forcibly stopped. Thereby, dew which may possibly be formed in the optical elements to be cooled can be inhibited like in the above-described embodiments. Incidentally, the charging capacity of the charging means is determined depending on the volume of the air passage and the cooling performance of the cooling device.

The projection display apparatus may also include heating means (such as a heater) configured to heat the optical elements to be cooled. In this case, the projection display apparatus heats the air in the air passage over a given period after the cooling by the cooling device is stopped. Further, the projection display apparatus drives the heating means by means of power supplied from the charging means when the power supply is forcibly stopped.

From this disclosure, various alternative embodiments, examples, and operation techniques will be easily found by those skilled in the art. Accordingly, the technical scope of the present invention should be determined only by the matters to define the invention in the scope of claims regarded as appropriate based on the description.

### INDUSTRIAL APPLICABILITY

The present invention can provide a projection display apparatus capable of inhibiting the formation of dew or frost in a cooling device.

1. A projection display apparatus including a light source, an optical element irradiated with light emitted from the light source, and a projection optics which projects light emitted from the optical element, the projection display apparatus comprising:
a cooling device including an air passage being a passage of an air, and a cooler which cools the air flowing through the air passage, wherein
the optical element is provided in the air passage,
the cooler terminates the cooling of the air flowing through the air passage upon receipt of an operation termination instruction to terminate an operation of the projection display apparatus, and
the light source keeps emitting the light even in a case of receiving the operation termination instruction.

2. The projection display apparatus according to claim 1, further comprising
an optical element controller which controls the optical element, wherein
the optical element includes a liquid crystal panel, an incident-side polarizing plate provided at a light-incident-surface side of the liquid crystal panel, and an output-side polarizing plate provided at a light-outgoing-surface side of the liquid crystal panel, and
upon receipt of the operation termination instruction, the optical element controller controls the liquid crystal panel so that the light emitted from the light source is shielded by the output-side polarizing plate.

3. The projection display apparatus according to claim 1, further comprising:
an optical element controller which controls the optical element; and
a light-shielding shutter provided at a light-outgoing side of the optical element, wherein
the optical element includes a liquid crystal panel, an incident-side polarizing plate provided at alight-incident-surface side of the liquid crystal panel, and an output-side polarizing plate provided at a light-outgoing-surface side of the liquid crystal panel,
upon receipt of the operation termination instruction, the optical element controller controls the liquid crystal panel so that the light emitted from the light source is transmitted through the output-side polarizing plate, and
upon receipt of the operation termination instruction, the light-shielding shutter shields the light emitted from the optical element.

4. The projection display apparatus according to claim 3, wherein the light-shielding shutter is provided in the air passage.

5. The projection display apparatus according to any one of claims 2 and 3, further comprising
a light-amount controller which controls a light amount of light to be irradiated on the optical element, wherein
the light amount of light to be irradiated on the optical element is set at a predetermined light amount in a normal operation state, and
upon receipt of the operation termination instruction, the light-amount controller performs control such that light having a smaller light amount than the predetermined light amount is irradiated on the optical element.

6. The projection display apparatus according to claim 5, wherein
the light source include a plurality of light sources, and
upon receipt of the operation termination instruction, the light-amount controller performs control such that only light emitted from some of the plurality of light sources is irradiated on the optical element.

7. The projection display apparatus according to claim 1, wherein
the cooling device includes a circulator which circulates the air in the air passage, and
the circulator circulates the air in the air passage even in the case of receiving the operation termination instruction.

8. The projection display apparatus according to claim 5, wherein the light-amount controller controls the light amount of light to be irradiated on the optical element by controlling power supplied to the light source.

9. The projection display apparatus according to claim 5, wherein the light-amount controller performs control such that the light having a smaller light amount than the predetermined light amount is irradiated on the optical element until a predetermined length of time passes after the receipt of the operation termination instruction.

10. The projection display apparatus according to claim 5, wherein
the cooling device includes a temperature sensor which detects a temperature in the air passage, and
the light-amount controller performs control such that the light having a smaller light amount than the predetermined light amount is irradiated on the optical element until the temperature detected by the temperature sensor increases to a predetermined temperature after the receipt of the operation termination instruction.

11. The projection display apparatus according to claim 5, wherein
the cooling device includes a temperature sensor which detects a temperature of the cooler, and
the light-amount controller performs control such that the light having a smaller light amount than the predetermined light amount is irradiated on the optical element until the temperature detected by the temperature sensor increases to a predetermined temperature after the receipt of the operation termination instruction.

12. The projection display apparatus according to claim 5, further comprising
a light-amount iris unit provided between the light source and the optical element and formed of a light-shielding member, wherein
the light-amount controller controls the light amount of light to be irradiated on the optical element by controlling the light-amount iris unit.
